(19) United States
(12) Patent Application Publication
(10) Pub. No.: US 2006/0145680 A1
(43) Pub. Date: Jul. 6, 2006

(54) Method for analyzing the inner temperature field and flow field in power transformers

(75) Inventor: Bor-Wen Shu, Taipei City (TW)

Correspondence Address: LOWE HAUPTMAN BERNER, LLP, 1700 DIAGONAL ROAD, SUITE 300, ALEXANDRIA, VA, 22314, US

(73) Assignee: TATUNG CO., LTD., Taipei City (TW)

(21) Appl. No.: 11/224,105

(22) Filed: Sep. 13, 2005

(30) Foreign Application Priority Data
Dec. 31, 2004 (TW) 93141778

(51) Int. Cl. H01F 21/00; H01F 19/00

(52) U.S. Cl. 323/355

(57) ABSTRACT

A method for analyzing the inner temperature field and flow field in power transformers uses an Icepak application™ to simulate at least one value of the component the power transformer. Steps: inputting at least one first parameter value of the component of the power transformer, and inputting a calculated heat flux value of the component of the power transformer; the parameter such as material characteristics and loading conditions of the power transformer, length, width, height dimensions of the case of the power transformer and so on. Furthermore, generating a model value of a power transformer; establishing grid values of the power transformer model; calculating the heat transfer data of temperature field and flow field; and outputting the results in graphs so as to obtain an efficient, easily improved, and optimum internal components design in power transformers based on the simulation data to gain the best power transformer heat distributing design.

### BACKGROUND OF THE INVENTION

1.Field of the Invention

The present invention relates to a method for analyzing the inner temperature field and the flow field in power transformers. More particularly, the invention relates to a method for simulating the inner temperature and the flow appearance in power transformers by using an Icepak Application™.

2. Description of Related Art

Currently, the circuit of a power transformer is composed of more than two different winding circuits and a same one common magnetic circuit. Furthermore, the windings which are independent with each other within the power transformer are immersed in insulating oil or insulating gas. Hence, power can be transmitted from a winding to another winding by the common magnetic circuit to making these different winding circuits are connected. When a power transformer is working, thermal energy is produced and the temperature of cores and windings rises due to the iron loss and copper loss are occurred. This will be lead to whole temperature of the power transformer increased. Furthermore, if the power transformer is continually operated at high temperatures for a long time, its life will be decreased, and damage will be caused even.

Presently, when designing a power transformer, a theoretical calculation of the inner temperature in power transformers is processed based on standards drafted by the International Electro-technical Commission (IEC), ANSI or IEEE. Hence, this method can simulate to estimate the highest temperature and average temperature of windings which are immersed in insulating oil via resistance methods and complex formulas, however, the estimated values are just theoretical values. And it's hardly to compare accuracy with actually values in a real power transformer, especially as the manufacturing process of power transformer is very complicated. And even a small change in the manufacturing process will cause the theoretical calculating values to be useless so that they need to be re-designed and re-calculated values. Therefore, it is difficult to calculate the inner temperature in the power transformer efficiently, exactly, and quickly by conventional methods which improvements are desired.

Therefore, it is desirable to provide an improved speech recognition method to mitigate and/or obviate the aforementioned problems.

### SUMMARY OF THE INVENTION

Providing a method for analyzing the inner temperature field and flow field in power transformers is the present invention's object. By using the appearance dates of inner temperature field and flow field in power transformers simulated by a computer, we can improve the inner components distribution design of the power transformer to efficiency and best one.

To achieve the object, the present invention provides the method for analyzing inner temperature field and flow field in power transformers comprises the steps of: (A) inputting at least one first parameter value of the one component of the power transformer, and inputting a calculated heat flux value of the power transformer; (B) inputting at least one second parameter value of the one component of the power transformer; (C) Generating model value of the component of the power transformer; (D) establishing grid values of the power transformer; (E) calculating result values based on the mesh model of the power transformer; and (F) showing temperature field and flow field in graphs by reprocessing the calculation results from step (E).

The method as described above in step (A), further includes the steps of: (A1) inputting a length, a width, and a height dimensions of the case of the power transformer; (A2) inputting a length, a width, and a height dimensions of cores, and windings of the power transformer; and (A3) inputting a thickness and the stray loss of the case of the power transformer.

The method as described above, the first parameter value comprises: material characteristics and loading conditions of the power transformer.

The method as described above, wherein in step (A3), the stray loss of the power transformer is built by the function ‘Source’ of the Icepak Application™.

The method as described above, wherein in step (A), he input value of heat flux is the result ratio of a real component's area to a simulated component's area.

The method as described above, wherein in step (B), the second parameter value is the characteristic of the working flow of the power transformer.

The method as described above, wherein in step (E), the result values include: the heat transfer data of the cores, windings, outer case, working flow, and other components of the power transformer.

Other objects, advantages, and novel features of the invention will become more apparent from the following detailed description when taken in conjunction with the accompanying drawings.

### BRIEF DESCRIPTION OF THE DRAWINGS

FIG. 1 is a flow chart for analyzing inner temperature field and flow field in power transformers according to an embodiment of the present invention.

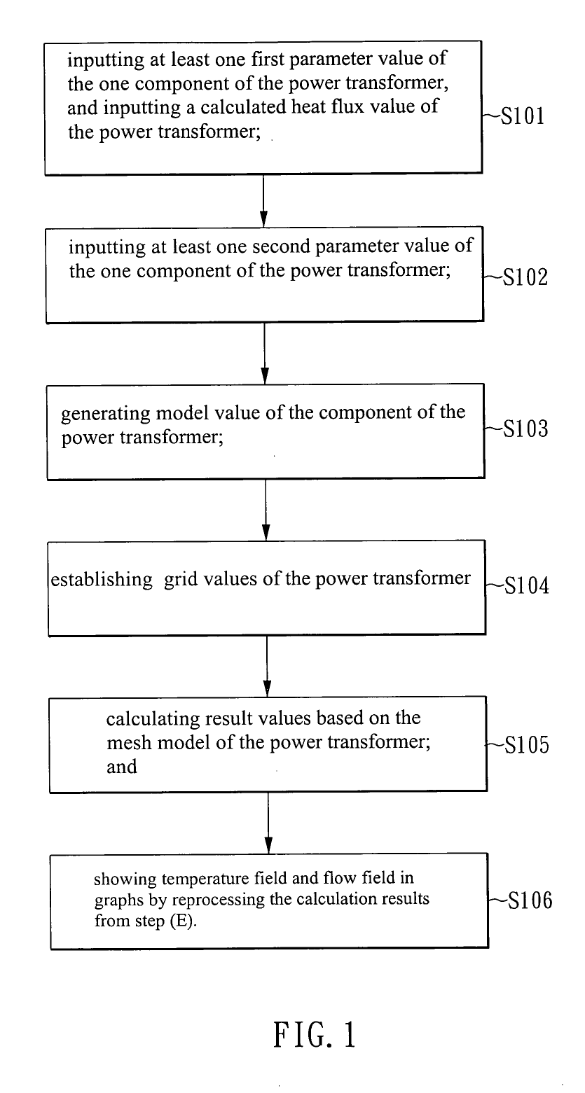

FIG. 2 is a stereogram of a structure of the grid model according to an embodiment of the present invention.

FIG. 3 is a detail flow chart of constructing a module grid of a power transformer according to an embodiment of the present invention.

FIG. 4 is a Z side view of the flow field in an X axis cutting plane according to an embodiment of the present invention.

FIG. 5 shows a Z side view of the flow field in a Y axis cutting plane according to an embodiment of the present invention.

FIG. 6 shows a Y side view of the flow field in Z axis cutting plane according to an embodiment of the present invention.

FIG. 7 shows a velocity field graph of the flow field in the Z axis cutting plane according to an embodiment of the present invention.

FIG. 8 shows a down view velocity field graph of the flow field in the Y axis cutting plane above windings of a preferred embodiment according to an embodiment of the present invention.

### DETAILED DESCRIPTION OF THE PREFERRED EMBODIMENT

For easily understanding the present invention, there is illustrated below a preferred embodiment as described.

In the following description, a preferred embodiment of the invention is described with regard to preferred process steps. However, those skilled in the art would recognize, after perusal of this application™ that embodiments of the invention might be implemented using a variety of other techniques without undue experimentation or further invention, and that such other techniques would be within the scope and spirit of the invention.

The method for analyzing inner temperature field and flow field in power transformers utilizes the Icepak application™ to simulate and analyze at least one value of the component the power transformer. A power transformer model is constructed via the Icepak application and the temperature of windings of the power transformer is simulated.

This embodiment simulates that a transformer cools down under natural airflow, and the major specifications and conditions are shown in a table below:

TABLE 1
Transformer Initial Conditions Table

| | Specification | | Remark |
|---|---|---|---|
| Rated Specification | 15/20/25MVA | | Medium-carbon |
| | 69KV-23.9/11.95KV | | Steel |
| Load Current | Low Voltage | High voltage | Rated Value |
| | 262/483/604A | 126/167/209A | |

| | | |
|---|---|---|
| Internal Dimensions | 3650L*2600W*1300H (mm) | Internal space |
| Case | Thickness: 9 mm | Medium-carbon |
| | | Steel |
| Limb Core | Section area: 1663.35*1425H | Silicon Steel |
| Yoke Core | Section area: 1663.35*2400H | Silicon Steel |
| Low V. Windings | 340 (outer radius)*270 | Pure Copper |
| | (internal radius)*1060H | |
| High V. Windings | 458 (outer radius)*369 | Pure Copper |
| | (internal radius)*1060H | |
| Heat Sink | Efficacious radiation area: | Medium-carbon |
| | 92,412,000 mm² | Steel |
| Insulating Oil | SHELL DIALA-A | Mineral Oil |

This embodiment of the present invention can utilize the Icepak application™ to simulate the inner temperature field and flow field of the components of the power transformer based on the conditions listed above. The detail of this embodiment is described in the following.

Inputting at least one first parameter value of the one component of the power transformer, and inputting a calculated heat flux value of the power transformer, (step S101)

Therein the first parameter includes components dimensions, characteristics, and load current of the power transformer as listed in Table 1, and as described, wherein the simulated load conditions are represented as: 69 kV load voltage and 126 A on the primary side; 11.95 kV output voltage and 124 A (2*62=124) on the secondary side; simulating situation at the power transformer capacity is 15 MVA in air environment by natural convection. In addition, the temperature boundary condition further includes four conditions: default, opening, grille and wall in the Icepak Application™. In this embodiment, the wall condition is selected for simulating real margin thickness and heat flux.

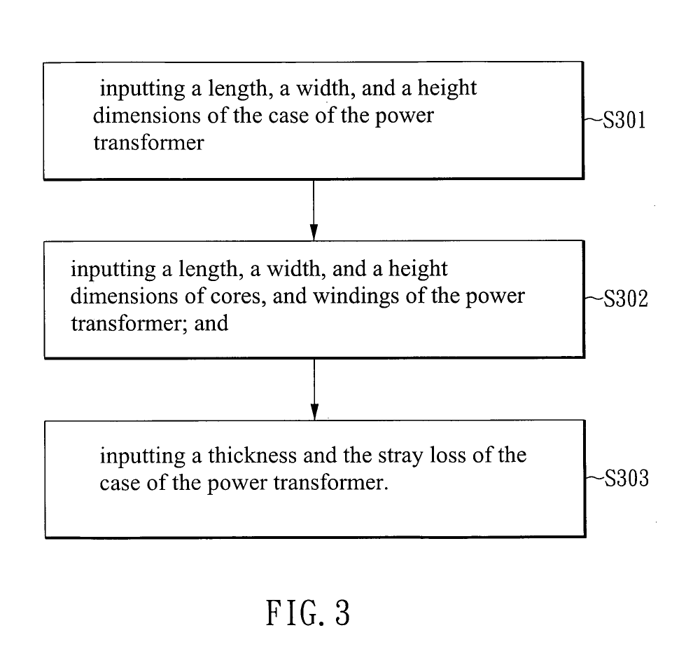

With reference to FIG. 3, the inputting of the first parameter value of the one component of the power transformer step further includes the steps of: inputting a length, a width, and a height dimensions of the case of the power transformer; (step S301); planning the same margin dimensions as the real power transformer's outer case dimensions via the Icepak application™; inputting a length, a width, and a height dimensions of cores, and windings of the power transformer; (step S302); constructing basic dimensions of the cores, low Voltage windings and high Voltage windings (such as length, width, height, radius and so on) based on the real distances and dimensions from each component of the power transformer; inputting a thickness and the stray loss of the case of the power transformer; (Step S303). Besides, considering the magnetic flux made from the core of the power transformer produce a stray loss on the outer case, this embodiment adds a stray loss source on the margin wall.

Next, inputting at least one second parameter value of the one component of the power transformer; (step S102), wherein the second parameter is the characteristic of the working flow of the power transformer, which can be selected from many modes in Icepak Application™, such as zero-equation turbulent flow mode, k-ε, turbulent flow mode, enhanced two-equation turbulent flow mode, and Spalart-Allmaras turbulent flow mode. In this embodiment, since it is a steady-state simulation under a rated load without a time factor discussed, so the zero-equation turbulent flow mode is selected for simulation.

Next, generating model values of the components of the power transformer, (step S103). The model setting information is generated based on the inputting power transformer characteristics as described in the steps above so that the simulated power transformer condition is conformed to the working flow characteristics of the real power transform.

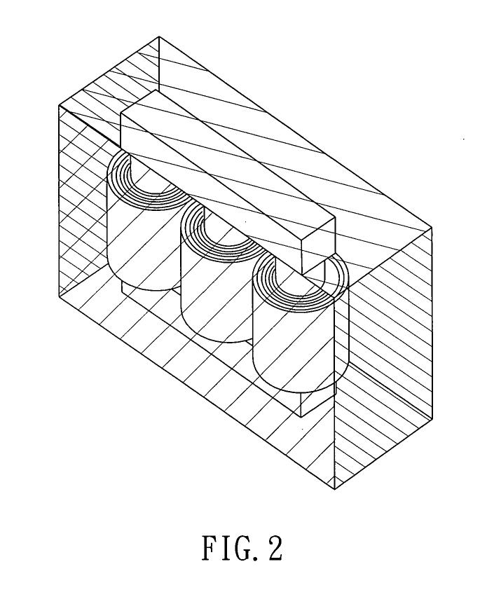

Fourthly, establishing a grid value of the power transformer model, (step S104). In this embodiment, an unstructured grid which maximum unit size is 0.08 m*0.08 m*0.08 m is used to make the power transformer component module be meshed, thereby constructing a 3-D power transformer grid graph, (FIG. 2), which includes the conditions as described in FIG. 3.

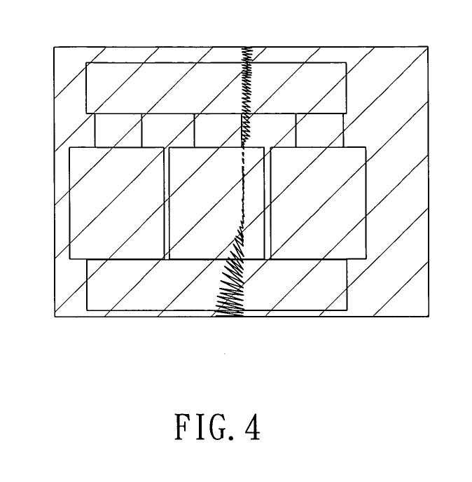

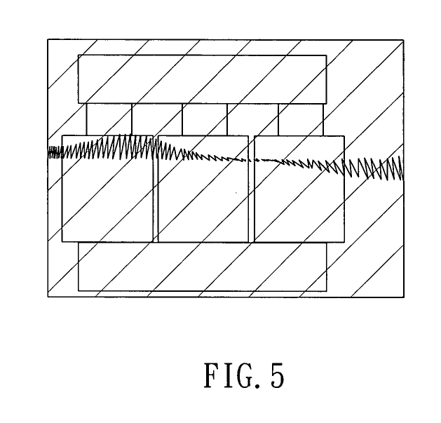

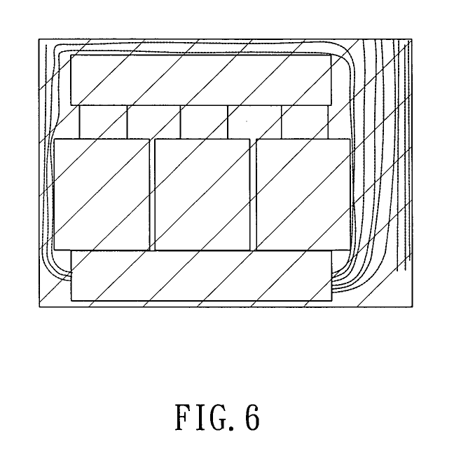

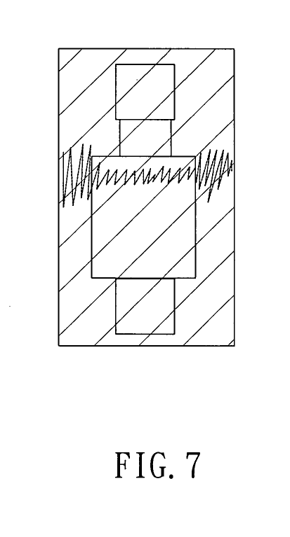

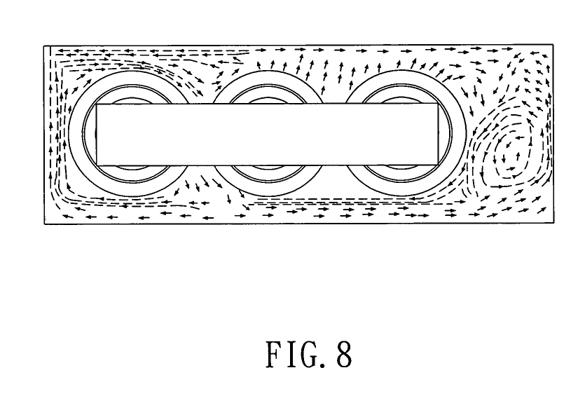

Then, calculating result values based on the meshed module data of the power transformer, (step S105). That is calculating result values via data built from the step S101 to the step S103, and via the meshed module grid constructed from the step S104 by using the Icepak application™ programming. These results such as mass, pressure, velocity, and temperature of components of the power transformer; the grid numbers grids, mesh element quality, Re, Pr etcetera of components of the power transformer; the iterative calculation resulting curves in velocity, energy, and continuity of components of the power transformer, and the heat transmission data of cores, windings, outer case, and working flow. With reference to FIG. 4, FIG. 5, FIG. 6, FIG. 7, and FIG. 8, the flow field information in the power transformer is shown. Finally, according to the result values above, the temperature field and flow field can be shown in graphs by reprocessing the calculation results via the Icepak application™, (step S106). More than that, these transferred resulting data are shown in colorful graphs and displayed in tables.

Although the present invention has been explained in relation to its preferred embodiment, it is to be understood that many other possible modifications and variations can be made without departing from the spirit and scope of the invention as hereinafter claimed.

What is claimed is:

1. A method for analyzing an inner temperature field and flow field in power transformers comprising the steps of:
(A) inputting at least one first parameter value of the one component of the power transformer, and inputting a calculated heat flux value of the power transformer;
(B) inputting at least one second parameter value of the one component of the power transformer;
(C) generating model value of the component of the power transformer;
(D) establishing grid values of the power transformer;
(E) calculating result values based on the mesh model of the power transformer; and
(F) showing temperature field and flow field in graphs by reprocessing the calculation results from step (E).

2. The method as claimed in claim 1, wherein in step (A) the first parameter value comprises: material characteristics and loading conditions of the power transformer.

3. The method as claimed in claim 1, wherein step (A) further includes the steps of:
(A1) inputting a length, a width, and a height dimensions of the case of the power transformer;
(A2) inputting a length, a width, and a height dimensions of cores, and windings of the power transformer; and
(A3) inputting a thickness and the stray loss of the case of the power transformer.

4. The method as claimed in claim 3, wherein in step (A3), the stray loss of the power transformer is built by the function ‘Source’ of the Icepak Application™.

5. The method as claimed in claim 1, wherein in step (A), the input value of heat flux is the result ratio of a real component's area to a simulated component's area.

6. The method as claimed in claim 1, wherein in step (B), the second parameter value is the characteristic of the working flow of the power transformer.

7. The method as claimed in claim 1, wherein in step (E), the result values include: the heat transfer data of the cores, windings, outer case, working flow, and other components of the power transformer.
